(19) United States
(12) Patent Application Publication
(10) Pub. No.: US 2026/0196248 A1
(43) Pub. Date: Jul. 9, 2026

(54) CUSTOMIZING VIDEO CONTENT USING MACHINE LEARNING MODELS

(71) Applicant: INTERNATIONAL BUSINESS MACHINES CORPORATION, ARMONK, NY (US)

(72) Inventors: YUAN YUAN DING, SHANGHAI (CN); SHI YUN LIANG, SHANGHAI (CN); ZHONG FANG YUAN, XI'AN (CN); TONG LIU, XI'AN (CN)

(21) Appl. No.: 19/011,556

(22) Filed: Jan. 6, 2025

(51) Int. Cl. G11B 27/036; G06T 11/00; G06V 10/774; G06V 20/40

(52) U.S. Cl. CPC G11B 27/036; G06T 11/00; G06V 10/774; G06V 20/41; G06V 20/47

(57) ABSTRACT

Customizing video content using machine learning models, includes: identifying, in an input video, one or more objects; generating, based on information associated with a user, a natural language description of customized video content; and generating, by a machine learning model, based on the natural language description of customized video content and the input video, the customized video content comprising the one or more objects from the input video and replacement video content for portions of the input video other than the one or more objects.

### BACKGROUND

The present disclosure relates to machine learning models and using the power of such artificial intelligence to enhance editing of video content and to perform user-focused customization of video content.

### SUMMARY

According to embodiments of the present disclosure, various methods, systems and products for customizing video content using machine learning models are described herein. In some aspects, customizing video content using machine learning models includes identifying, in an input video, one or more objects; generating, based on information associated with a user, a natural language description of customized video content; and generating, by a machine learning model, based on the natural language description of customized video content and the input video, the customized video content comprising the one or more objects from the input video and replacement video content for portions of the input video other than the one or more objects. In some aspects, a computer system may include a processor set; one or more computer readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth an example computing environment according to aspects of the present disclosure.

FIG. 2 sets forth an example pictorial representation of customizing video content using machine learning models in accordance with some embodiments of the present disclosure.

FIG. 3 sets forth a diagram of an example process flow for customizing video content using machine learning models in accordance with some embodiments of the present disclosure.

FIG. 4 sets forth an example pictorial representation of generating a mask for customizing video content using machine learning models in accordance with some embodiments of the present disclosure.

FIG. 5 sets forth a diagram of an example process for training a machine learning model for customizing video content using machine learning models in accordance with some embodiments of the present disclosure.

FIG. 6 sets forth a diagram of an example process for customizing video content using machine learning models in accordance with some embodiments of the present disclosure.

FIG. 7 sets forth a flowchart of an example method of customizing video content using machine learning models in accordance with some embodiments of the present disclosure.

FIG. 8 sets forth a flowchart of another example method of customizing video content using machine learning models in accordance with some embodiments of the present disclosure.

FIG. 9 sets forth a flowchart of another example method of customizing video content using machine learning models in accordance with some embodiments of the present disclosure.

FIG. 10 sets forth a flowchart of another example method of customizing video content using machine learning models in accordance with some embodiments of the present disclosure.

FIG. 11 sets forth a flowchart of another example method of customizing video content using machine learning models in accordance with some embodiments of the present disclosure.

FIG. 12 sets forth a flowchart of another example method of customizing video content using machine learning models in accordance with some embodiments of the present disclosure.

### DETAILED DESCRIPTION

Videos, once created, are generally aired for long periods of time. Due to the static nature of these videos, they cannot take into account changes in seasons, events, locations, or specific attributes of particular users. Accordingly, these videos may become outdated or irrelevant to particular regions or users. Although different versions of videos may be created for particular times or regions, this requires manually shooting and editing multiple different versions of a video, making the overall process time consuming and labor intensive. Advances in generative artificial intelligence have made possible the creation of original video content from natural language descriptions. However, these solutions require creation of entirely new video content and are unable to preserve or reuse elements from previously created video content.

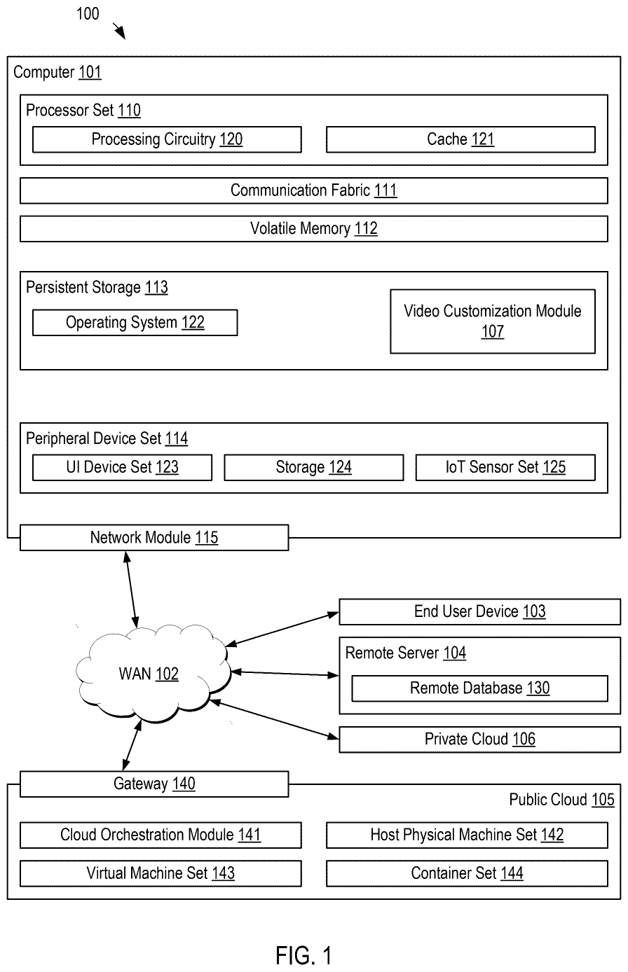

With reference now to FIG. 1, shown is an example computing environment according to aspects of the present disclosure. Computing environment 100 contains an example of an environment for the execution of at least some of the computer code involved in performing the various methods described herein, such as the video customization module 107. In addition to the video customization module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the video customization module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in the video customization module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the video customization module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

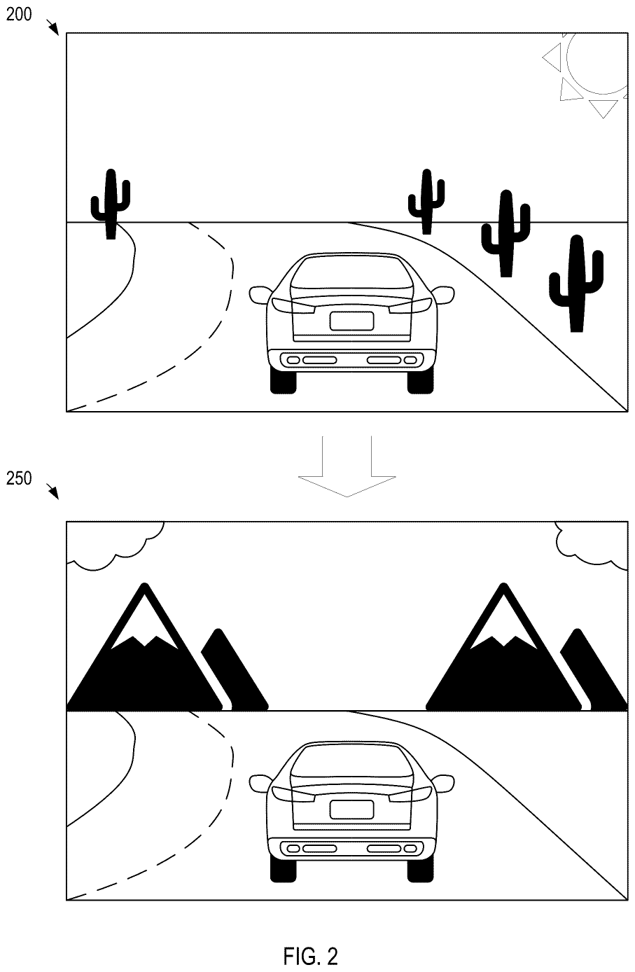

FIG. 2 sets forth an example pictorial representation of customizing video content using machine learning models in accordance with some embodiments of the present disclosure. Although the following discussion is presented in the context of video content edited according to geographical interests of a user, readers will appreciate that the customized editing approaches set forth herein are not limited to geographical interests and may be applied to any other type of user-specific customizations of video content as can be appreciated. FIG. 2 shows a frame representing an example input video 200. Here, the input video 200 is a car commercial depicting a car being driven through a sunny desert. Assume that this input video 200 is to be customized for presentation to a particular user according to the approaches set forth herein. For example, assume that the user lives in the Pacific Northwest region of the United States, which does not include large amounts of desert but does include mountains, cloudy weather, and the like. In order to appeal to the region of the user, the input video 200 may be customized by removing the desert background, replacing it so that the car is instead driving through the mountains on a cloudy day, thereby producing the output video 250.

Particularly, the background of the input video 200 may be removed and replaced with replacement content generated using generative artificial intelligence (AI) or other machine learning models as can be appreciated. As referred to herein, generative AI uses models such as neural networks, including large language models (LLMs), large multimodal models (LMMs), and the like to generate content, such as text, code, graphics, animations, video, audiovisual representations, audio, speech, etc., in response to prompts. The generative AI models are trained using a corpus of training data content to learn the patterns and structure of that content. The generative AI model may then generate new content having the characteristics learned from the training data. Prompts may include text, code, audio, graphic, video, and/or representations in any other media. Such prompts may be provided to the generative AI model as a natural language input. For example, the approaches set forth herein may interact with a generative AI model using predefined prompts, dynamically generated prompts, prompts that include some portion of dynamically generated content (e.g., through the use of templates and dynamically populated variables), and/or the like.

In this example, the replacement content (e.g., the replacement background to be included in the output video 250) may be generated by a LMM or another multimodal model trained or configured for video content generation. Here, the essential feature of the input video 200, the car, is preserved in the output video 250, only replacing the background to be more tailored to a particular user. Readers will appreciate that the pictorial representation of FIG. 2, whereby the background of the input video 200 is replaced to reflect the region of the user, is merely exemplary and that, as will be described in further detail below, videos and/or images may be customized based on a variety of factors related to a user and/or other events.

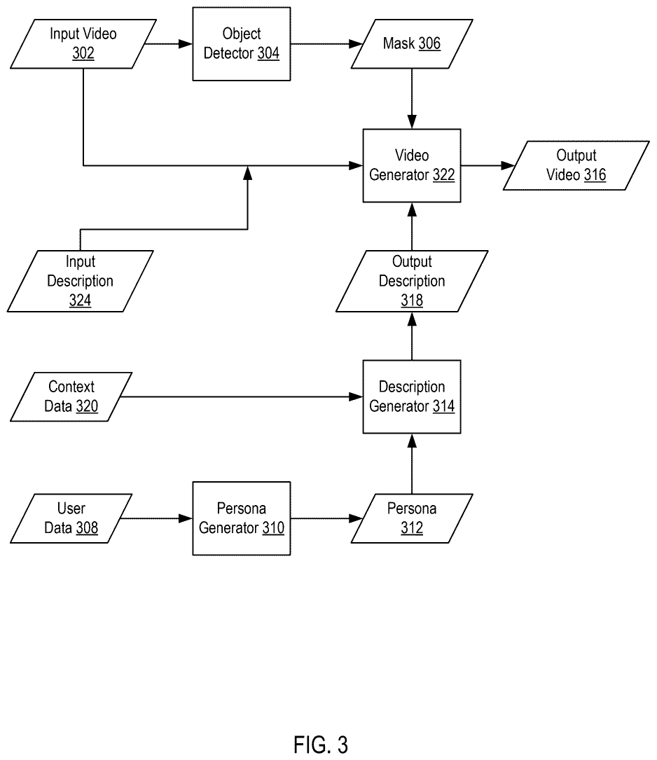

FIG. 3 sets forth a diagram of an example process flow for customizing video content using machine learning models in accordance with some embodiments of the present disclosure. To begin, an input video 302 is provided as input to an object detector 304 that identifies, in the input video 302, one or more objects. An “object” as used herein refers to a digital representation of a physical object. In other words, an object is a region in the input video 302 of arbitrary shape with some semantic meaning. In some embodiments, the object detector 304 may identify the one or more objects by identifying a location of the one or more objects in each frame of the input video 302. In some embodiments, this may include identifying differing objects across frames of the input video 302, such as where a particular object is not present in all frames of the input video 302.

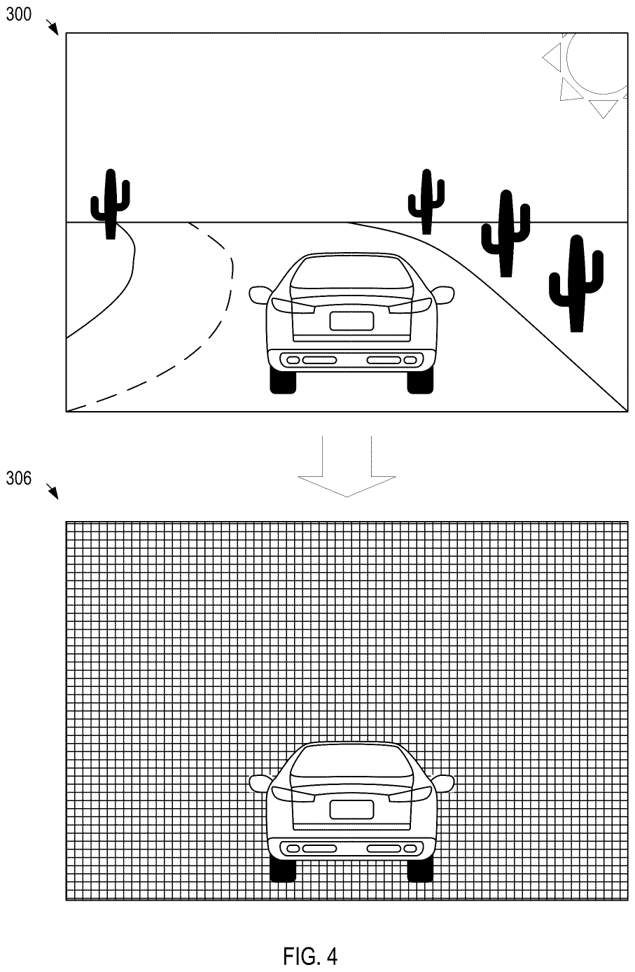

In some embodiments, the object detector 304 may provide, as output, one or more masks 306. For example, in some embodiments, the object detector 304 may provide, as output, for each frame of the input video 302, a corresponding mask 306 identifying those objects found in a particular frame. As described herein, a mask 306 for a given frame is data that identifies the particular pixels corresponding to objects in the given frame. In some embodiments, the mask 306 may include a collection of pixels (e.g., identifiers for particular pixels or the pixels themselves) of the corresponding frame. In some embodiments, the mask 306 may include bounding regions for each frame in the corresponding frame. For example, turning to FIG. 4, shown is an example pictorial representation of generating a mask 306 from a frame of input video 300 for customizing video content using machine learning models in accordance with some embodiments of the present disclosure. Here, the input video 302 whose frame 300 is shown in FIG. 4 is similar to the input video 200 of FIG. 2 in that it depicts a car driving through a desert. The object detector 304 identifies the car as an object in the frame 300 of the input video 302 and generates a mask 306 including the pixels of the car and excluding all other pixels from the frame 300 of the input video 302.

Turning back to FIG. 3, the object detector 304 may be implemented using any object detection algorithm or system for images and/or video, such as YOLO, or another object detection algorithm or system as can be appreciated by one skilled in the art. In some embodiments, rather than using a dedicated object detection algorithm or system, the object detector 304 may be implemented using a LMM or other multimodal generative AI model. For example, in some embodiments, a multimodal generative AI model may accept a prompt indicating that objects should be identified from the input video 302 or indicating particular objects or types of objects to be identified from the input video 302. In response to receiving this prompt, this multimodal generative AI model may then provide, as output, the masks 306 for the identified objects.

In order to customize the input video 302 for a particular user, user data 308 is processed by a persona generator 310 to generate a persona 312. As described herein, a persona 312 is data describing various aspects or attributes of a user. In some embodiments, the persona 312 may be encoded as a natural language description of the user. The user data 308 may include data describing the user, activity of the user, and/or other information related to a particular user as can be appreciated. For example, the user data 308 may indicate, for a particular user, their age, gender, geographical location, interests, browsing history, video consumption history, product purchase history, device usage history, and/or other information. The user data 308 may be gathered or aggregated from a variety of sources. For example, in some embodiments, a user may have created a user profile accessible to the persona generator 310 with various data points related to the user. As another example, in some embodiments, portions of user data 308 may be accessed from one or more devices associated with the user, such as from applications executed on a user device. As a further example, cookies or other activity tracking information may be accessed from a user device. As yet another example, portions of user data 308 may be aggregated from and correlated using public or private data stores. Other sources of user data 308 are also contemplated within the scope of the present disclosure. Before tracking and storing the user data, consent from the user is obtained in accordance with applicable privacy regulations in the relevant jurisdiction.

The persona generator 310 processes the user data 308 to generate, for the user, a persona 312. In some embodiments, this may include generating the persona 312 specific to the particular user. In other words, in some embodiments, the content of the persona 312 may be dynamically generated for a particular user based on their user data. In some embodiments, the persona 312 may be generated by assigning the user to a predefined persona 312 from a collection of predefined personas 312.

In some embodiments, the persona generator 310 may be implemented using a generative AI machine learning model, such as an LLM, or another machine learning model as can be appreciated. For example, LLMs may be used to parse input data to generate text summaries, descriptions, or conclusions from the input data. Here, the persona generator 310 may include an LLM to generate the persona 312 as a natural language description or summary of the user based on their user data 308. In some embodiments, as LLMs are well-suited for summarizing, processing, or describing input text data and outputting text data, this may be achieved using an off-the-shelf or general purpose LLM that is not specifically trained for generating personas 312.

For example, the persona generator 310 may be provided with the following example prompt to generate a persona 312:
“As a consultant analyzer, please analyze customer services typical personas based on user segmentation and labels.
Output structure should be:
Persona Name:
Demographics
Age:
Gender:
Occupation:
Income:
Location:
Family size:
Background:
Goals:
Pain points:
Values:
Personality:
Behaviors:
Preferred communication channels:
How we can assist:
Here is the input of the user segmentation and labels:
{labels}”

The persona generator 310 may then provide, as output, the following persona 312:

Persona 1: The Budget-Minded Millennial
Persona Name: The Budget-Minded Millennial
Demographics
Age: 18-40
Gender: No preference
Occupation: Varied (students, young professionals)
Income: Lower-middle class
Location: Urban or suburban
Family size: Varies, may be single or starting a family
Background: Tech-savvy and comfortable using online resources. Values getting the most out of their money.
Goals: Resolve customer service issues quickly and efficiently at a minimal cost.
Pain Points: Long wait times, hidden fees, lack of self-service options.
Values: Efficiency, affordability, transparency
Personality: Calm, patient, resourceful.
Behaviors: Researches online before contacting customer service. Prefers self-service options (FAQs, chatbots) for simple issues. Uses email or social media for more complex issues.
Preferred communication channels: Website chat, email, social media
How we can assist: Offer clear and concise information on pricing and fees. Provide easily accessible self-service options. Have efficient and responsive email and social media support.

Readers will appreciate that, in some embodiments generating a persona 312 for a user may be performed independent of or asynchronous to any command or request to generate a customized output video 316 from some input video 302. For example, in some embodiments, the persona 312 for a user may be independently generated and stored for later use in generating customized output videos 316. Moreover, in some embodiments, a generated persona 312 may be repeatedly used for generating different customized output videos 316 for a user. In some embodiments, the persona 312 for a user may be periodically updated as new user data 308 is gathered so as to reflect the most recent and relevant user data 308.

The persona 312 is then provided as input to a description generator 314 that provides, as output, a stylistic description of how the resulting output video 316 should be customized or modified, shown as the output description 318. The output description 318 may be encoded as a natural language description of the output video 316 (e.g., of the style of the output video 316). For example, the output description 318 may indicate tonal qualities, visual elements, and/or the like. In some embodiments, the description generator 314 may be implemented using a generative AI machine learning model, such as an LLM, or another machine learning model as can be appreciated. As is set forth above, as LLMs are well-suited for summarizing, processing, or describing input text data and outputting text data, this may be achieved using an off-the-shelf or general purpose LLM that is not specifically trained for output descriptions 318.

In some embodiments, the description generator 314 may also accept input data aside from the persona 312 to generate the output description 318, shown as context data 320. The context data 320 may include information not specific to the user for which the output video 316 is generated. This may include, for example, additional attributes related to how, where, or when the output video 316 will be presented to the user. For example, the context data 320 may indicate weather information, upcoming or current holidays, trending events, or other information.

For example, the description generator 314 may accept the following prompt to generate an output description 318:
“Generate a meaningful video style description for the given user persona.
The video should consider the following external information, including seasonal context, weather conditions, and trending events.
Use the information to create a personalized and engaging video style that aligns with the user's preferences and current external factors.
User Persona:
{User_persona}
External Information:
Weather: {weather}
Season: {season}
Holiday: {holiday}
Trending Event: {trending event}
Please generate a personalized style description for video.”

The description generator 314 may then, in response, provide, as output, the following output description 318: “This video targets The Budget-Minded Millennial with a modern, tech-savvy, and minimalist style. Incorporate cozy, Christmas-themed visuals and highlight interesting new technology. Use a warm and friendly tone to maintain a personal touch.”

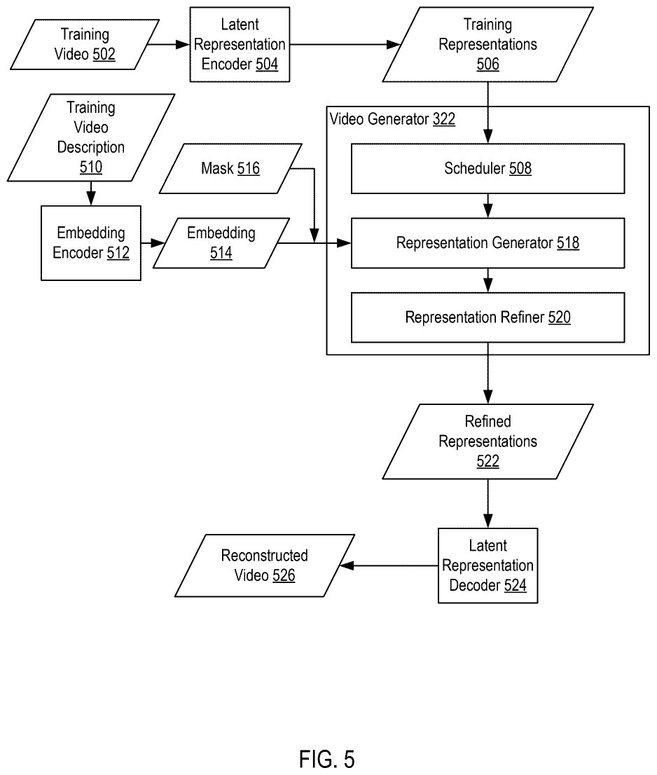

The output description 318 is then provided as an input to a video generator 322 that generates an output video 316. Particularly, the video generator 322 generates the output video 316 to conform to the output description 318 by replacing some portion of the input video 302 with dynamically generated replacement content (e.g., generated by the video generator 322 itself). The video generator 322 may be implemented using a specifically trained or fine-tuned multimodal generative AI model, such as a diffusion model, or another machine learning model as can be appreciated. Specific approaches for training and implementing the video generator 322 are described in further detail below, e.g., with respect to the description of the example process shown in FIG. 5. To do so, the video generator 322 also accepts the masks 306 as input to indicate the particular portions of the input video 302 to be included in the output video 316. In other words, the masks 306 serve to indicate, for each frame of input video 302, the objects to be included in a corresponding frame of output video 316.

In some embodiments, the video generator 322 may also accept, as input, an input description 324: a natural language description of what is present or occurring in the input video 302. The input description 324 provides additional context to the video generator 322 as to what is occurring in the input video 302 so as to guide generation of the resulting output video 316. In some embodiments, this input description 324 may describe the input video 302 overall (e.g., a single description for the entire input video 302 or multiple descriptions for different segments or scenes in the input video 302), or may describe the input video 302 on a frame-by-frame basis. In some embodiments, the input description 324 may be generated by providing the input video 302 as input to a generative AI model or another machine learning model that provides, as output, the input description 324. As using generative AI models to produce text summaries or descriptions of video is known in the art using general purpose or off-the-shelf generative AI models, the input description 324 may be generated using any suitable generative AI model as can be appreciated.

The resulting output video 316 is customized for a particular user. For example, the output video 316 may be customized for the particular interests of the user, the region of the user, upcoming holidays or events, and the like. This may improve overall video enjoyment quality and user engagement, improving the user experience and overall system utility.

Next, FIG. 5 sets forth a diagram of an example process for training a video generator 322 for customizing video content using machine learning models in accordance with some embodiments of the present disclosure. Particularly, the training process for the video generator 322 serves to train the video generator 322 to ensure that generated frames are temporally consistent and align with objects identified by masks. In other words, it may be assumed that the video generator 322 is pre-trained to generate the replacement video content itself (e.g., to generate images and video from text descriptions), such as by being derived from an existing diffusion or other multimodal generative AI model for generating image and video content. Here, the training process serves to ensure that the generated replacement content aligns visually with the objects identified by masks (e.g., the objects identified by the masks are in the correct spatial location relative to the generated replacement content) and is temporally consistent with these objects (e.g., changes in the replacement content over time across frames are consistent with changes to the identified objects across the frames). Returning to the examples above whereby the background of a car driving through a desert is replaced by a mountain road, this training process does not serve to train the video generator 322 on how to generate an image of a mountain road in general, but rather serves to train the video generator 322 on how to generate images that are spatially and temporally consistent with the movement and placement of the car across frames.

To begin, a training video 502 is provided as input to a latent representation encoder 504. The training video 502 is some sample of video training data. The latent representation encoder 504 is a trained machine learning model that accepts some input data and that, in response, provides, as output, one or more latent representations for that data. As generating latent representations of input data is known in the art, the latent representation encoder 504 may include any encoder for latent representations as can be appreciated, such as a Variational Autoencoder (VAE) encoder: an encoder component of a VAE neural network architecture.

A latent representation of input data is a compressed or reduced-dimensional encoding of the input data that emphasizes and preserves essential features of the input data. Here, each frame of the training video 502 is encoded into a corresponding latent representation, shown as training representations 506. These training representations 506 are provided as input to a scheduler 508. As would be understood by one skilled in the art, a scheduler 508 is a component of diffusion models or other machine learning models that introduce noise into the input data. Here, the scheduler 508 introduces noise into the training representations 506 to introduce variability during training, ensuring that the trained video generator 322 can handle a wide range of inputs.

A training video description 510 is provided as input to an embedding encoder 512 to produce an embedding 514. The training video description 510 is a natural language description of the training video 502 that may be generated according to similar approaches as are set forth above with respect to generating an input description 324 from input video 302. An embedding 514 is a vector encoding of input data that maps the input data (e.g., the training video description 510) to a point in multidimensional space. Readers will appreciate that encoders that convert data into vector embeddings are known components of neural networks or other machine learning models for converting input data into numerical forms that may be processed by the model. In some embodiments, the embedding encoder 512 may include an encoder of a neural network or machine learning model for text and image processing, such as an encoder of a Contrastive Learning In Pretraining (CLIP) model.

The embeddings 514, masks 516 for the training video 502 (generated according to similar approaches as are described above), and the noisy training representations 506 from the scheduler 508 are provided as input to a representation generator 518. When generating customized output video, the representation generator 518 will be used to generate, as latent representations, frames that include replacement content as well as the identified objects to be included in the customized output video. In some embodiments, the output representation generator 518 may include or be based on a pre-trained text-to-video or text-to-image diffusion model such as V-ControlNet. Accordingly, the training process as described herein serves to refine generation of replacement content that takes into account control signals such as masks 516 and embeddings 514. During training, there is no description of specific replacement content to be generated for the training video 502. Instead, during training, the representation generator 518 may tune or adjust an input representation to ensure that the key features identified by the masks 516 and/or described in the embeddings 514 are emphasized over other features. This emphasizing ensures that, when generating customized output video, the generated video maintains the integrity of the key elements highlighted by the masks 516.

The noisy training representations 506 as modified by the representation generator 518, along with the masks 516, are then provided as input to a representation refiner 520. The representation refiner 520 is a trained machine learning model, such as a neural network or convolutional neural network, that further processes the input representations to ensure spatial and temporal consistency across frames, particularly with respect to key objects identified by the masks 516. For example, in some embodiments, the representation refiner 520 may include a V-UNet network: a convolutional neural network used for precise and fast image segmentation. In some embodiments, the representation refiner 520 may implement one or more convolutional layers for spatial feature extraction and refinement based on the masks 516. As another example, in some embodiments, the representation refiner 520 may implement one or more attention layers for preserving temporal consistency based on object tracking across frames.

The representation refiner 520 then provides its refined representations 522 as output. Here, the refined representations are based on the training representations 506 without including additional replacement content, effectively allowing the training video 502 to be reconstructed from the refined representations 522. The refined representations 522 are provided as input to a latent representation decoder 524 that, in response, provides, as output, a reconstructed video 526 (e.g., a reconstructed version of the training video 502). The latent representation decoder 524 converts latent representations into their encoded data. As generating data from input latent representations is known in the art, the latent representation decoder 524 may include any decoder for latent representations as can be appreciated, such as a VAE decoder: a decoder component of a VAE neural network architecture. Thus, frames of the reconstructed video 526 may be generated by providing the corresponding refined representations 522 as input to the latent representation decoder 524.

The process described above is ultimately used to train the video generator 322 (e.g., the representation generator 518 and representation refiner 520) by comparing the reconstructed video 526 to the training video 502. Parameters of the representation generator 518 and representation refiner 520 may be iteratively modified across training cycles to minimize differences between the training video 502 and the reconstructed video 526, encouraging accurate and coherent video synthesis.

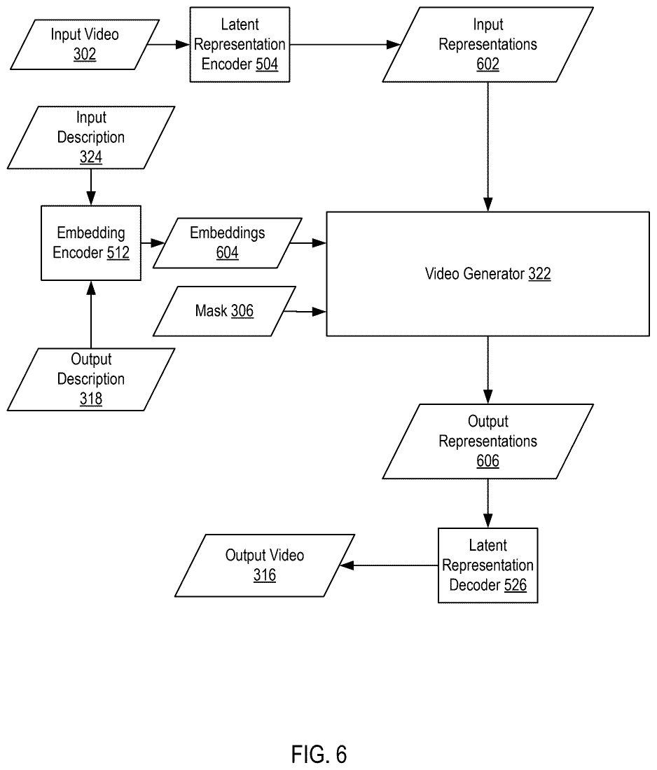

Turning now to FIG. 6, shown is a diagram of an example process for customizing video content using machine learning models in accordance with some embodiments of the present disclosure. Here, the video generator 322 has been trained according to the process described above and will generate customized video content, shown as output video 316, based on an input video 302. To begin, the input video 302 is provided as input to a latent representation encoder 504 (e.g., a VAE encoder) to generate input representations 602, which are latent representations of each frame of the input video 302. These input representations 602 are provided as input to the video generator 322.

An input description 324 and an output description 318 (e.g., generated based on a user persona 312 and potentially context data 320) are provided as input to an embedding encoder 512 (e.g., a CLIP encoder) to generate their corresponding embeddings 604. These embeddings 604, as well as masks 306 for the input video 302, are also provided as input to the video generator 322.

The video generator 322 then generates latent representations of frames of the output video 316, shown as output representations 606. For example, the output description 318 may be used as part of a prompt to generate replacement content for inclusion in the output representations 606. The video generator 322 may generate these output representations 606 using a representation generator 518 and representation refiner 520 that integrates the masks 306 as a control signal for the replacement content, ensuring spatial and temporal consistency with respect to identified objects across frames. These output representations 606 may then be decoded into output video 316 using a latent representation decoder 524.

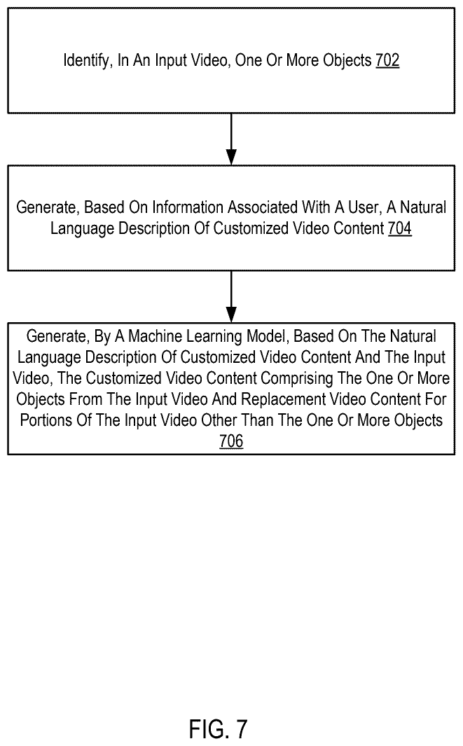

For further explanation, FIG. 7 sets forth a flowchart of an example method of customizing video content using machine learning models in accordance with some embodiments of the present disclosure. The method of FIG. 7 may be performed, for example, using a video customization module 107 of FIG. 1. The method of FIG. 7 includes identifying 702, in an input video, one or more objects. In some embodiments, identifying 702 the one or more objects may include identifying the one or more objects across multiple frames of the input video. In some embodiments, identifying 702 the one or more objects may include generating, for each frame of input video, a corresponding mask encoding or indicating those pixels corresponding to a particular identified object. In some embodiments, identifying 702 the one or more objects may be performed using an object detection algorithm or system such as YOLO. In some embodiments, identifying 702 the one or more objects may be performed using a multimodal generative AI model or another machine learning model as can be appreciated.

The method of FIG. 7 also includes generating 704, based on information associated with a user, a natural language description of customized video content. In some embodiments, the natural language description of the customized video content may include stylistic or tonal elements to be included in the customized video content, particular objects or elements to be included in the customized video content, and the like. In some embodiments, the information associated with the user may include various types of user data as can be appreciated. Such information may describe attributes of the user themselves, activity of the user, defined or learned preferences, and/or other user data.

In some embodiments, generating 704 the natural language description of the customized video content may include providing the information associated with the user (e.g., the user data) as input to a trained machine learning model that provides, as output, the natural language description of the customized video content. In some embodiments, this machine learning model may include an LLM, another generative AI model, or another machine learning model. In some embodiments, as will be described in further detail below, generating 704 the natural language description of the customized video content may include generating (e.g., using an LLM or another machine learning model) a persona describing the user and generating 704 the natural language description of the customized video content based on the persona and potentially other data.

The method of FIG. 7 also includes generating 706, by a machine learning model, based on the natural language description of customized video content and the input video, the customized video content comprising the one or more objects from the input video and replacement video content for portions of the input video other than the one or more objects. Generating 706 the customized video content may be performed according to similar approaches as are set forth above. The machine learning model used to generate the customized video content may include a multimodal generative AI model such as a LMM or another machine learning model as can be appreciated. The machine learning model may accept, as input, the input video, masks or other data identifying the one or more objects, the natural language description of the customized video content, derivatives thereof (e.g., latent representations and/or embeddings) and potentially other data.

The customized video content includes the identified 702 one or more objects and excludes other portions of the input video, instead replacing those other portions with replacement video content. This replacement video content may include, for example, background elements, foreground elements, and the like generated by the machine learning model for inclusion in the customized video content. Accordingly, in some embodiments, the machine learning model may include or be based on a model trained to generate image or video content based on text prompts. Here, the text prompt to generate 706 the customized video content may include the generated 704 natural language description of the customized video content.

For example, in some embodiments, to generate a given frame of customized video content for a corresponding frame of input video, the machine learning model may use a mask for the corresponding frame as a control signal to indicate the objects in that frame to be included in the frame of customized video. The machine learning model may then use these masks across multiple frames to generate replacement video content that is spatially and temporally consistent with the identified objects. Thus, each frame of customized video content includes the generated replacement content and the identified 702 objects in the corresponding frame of input video.

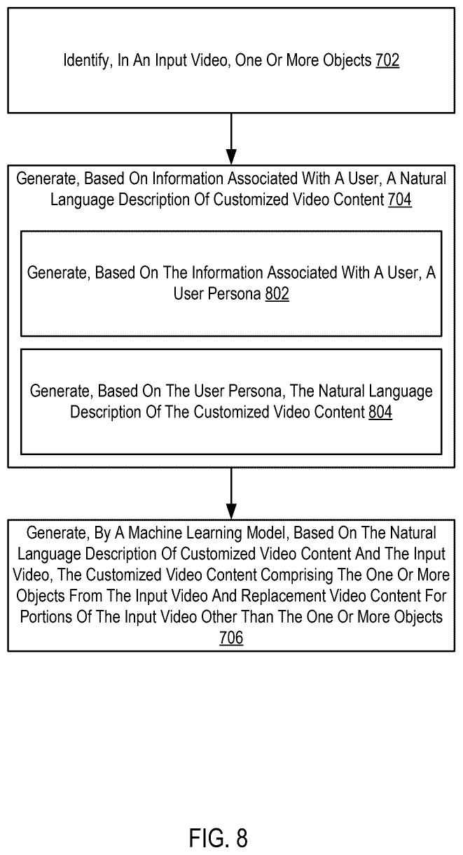

For further explanation, FIG. 8 sets forth a flowchart of another example method of customizing video content using machine learning models in accordance with some embodiments of the present disclosure. The method of FIG. 8 is similar to FIG. 7 in that the method of FIG. 8 also includes: identifying 702, in an input video, one or more objects; generating 704, based on information associated with a user, a natural language description of customized video content; and generating 706, by a machine learning model, based on the natural language description of customized video content and the input video, the customized video content comprising the one or more objects from the input video and replacement video content for portions of the input video other than the one or more objects.

The method of FIG. 8 differs from FIG. 7 in that generating 704, based on information associated with a user, a natural language description of customized video content includes generating 802, based on the information associated with a user, a user persona. A user persona is a natural language description or summary of the user (e.g., the user whose information serves as a basis for generating 706 the customized video content). In some embodiments, the user persona may be generated 802 by a machine learning model such as an LLM or another machine learning model. For example, the machine learning model may accept, as input, user data and provide, as output, the user persona. Readers will appreciate that this may leverage the ability of LLMs, including off-the-shelf or general purpose LLMs, to process, correlate, and summarize data across potentially many data sources into a natural language description or summary.

The method of FIG. 8 further differs from FIG. 7 in that generating 704, based on information associated with a user, a natural language description of customized video content also includes generating 804, based on the user persona, the natural language description of the customized video content. Here, the machine learning model (e.g., the LLM) used to generate 704 the natural language description of the customized video content may accept, as input, the generated 802 user persona, and potentially other data. Thus, information associated with the user may be correlated and summarized into a condensed or organized form. This user persona may then serve as a basis for generating 804 the natural language description of the customized video content (e.g., by the same or a different machine learning model).

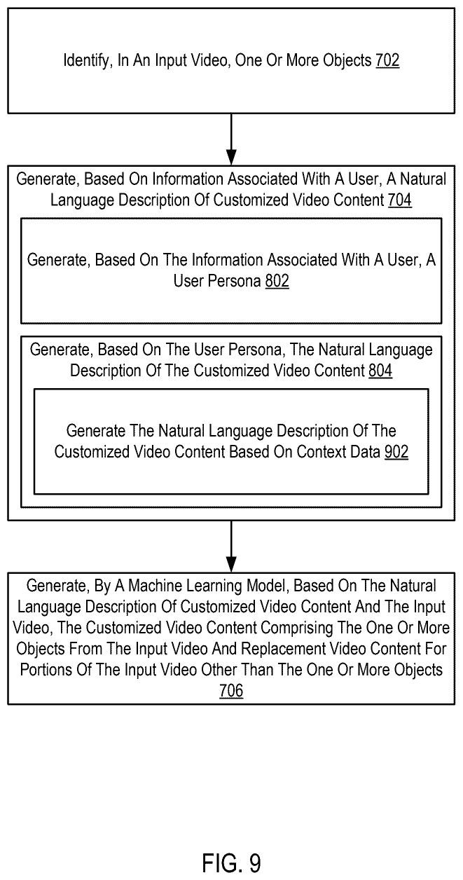

For further explanation, FIG. 9 sets forth a flowchart of another example method of customizing video content using machine learning models in accordance with some embodiments of the present disclosure. The method of FIG. 9 is similar to FIG. 8 in that the method of FIG. 9 also includes: identifying 702, in an input video, one or more objects; generating 704, based on information associated with a user, a natural language description of customized video content, including: generating 802, based on the information associated with a user, a user persona; and generating 804, based on the user persona, the natural language description of the customized video content; and generating 706, by a machine learning model, based on the natural language description of customized video content and the input video, the customized video content comprising the one or more objects from the input video and replacement video content for portions of the input video other than the one or more objects.

The method of FIG. 9 differs from FIG. 8 in that generating 804, based on the user persona, the natural language description of the customized video content also includes generating 902 the natural language description of the customized video content based on context data. The context data is information not specifically applicable to the user that may reflect a time when or a place where the user will consume the customized video content. For example, the context data may indicate current or trending events, holidays, weather conditions, or other information as can be appreciated. Thus, the resulting description of the customized video content, and therefore the customized video content, can reflect both particular aspects of the user as well as additional contextual information to further refine and tailor the customized video content.

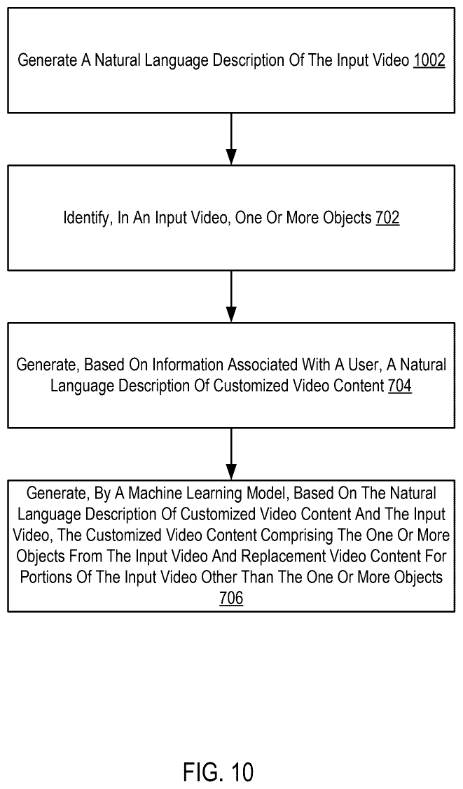

For further explanation, FIG. 10 sets forth a flowchart of another example method of customizing video content using machine learning models in accordance with some embodiments of the present disclosure. The method of FIG. 10 is similar to FIG. 7 in that the method of FIG. 10 also includes: identifying 702, in an input video, one or more objects; generating 704, based on information associated with a user, a natural language description of customized video content; and generating 706, by a machine learning model, based on the natural language description of customized video content and the input video, the customized video content comprising the one or more objects from the input video and replacement video content for portions of the input video other than the one or more objects.

The method of FIG. 10 differs from FIG. 7 in that the method of FIG. 10 also includes generating 1002 a natural language description of the input video. The natural language description of the input video may be generated 1002 using a multimodal generative AI model or another machine learning model as can be appreciated. The natural language description of the input video may include a description of the input video as a whole, descriptions of particular scenes or segments in the input video, frame-by-frame descriptions of the input video, and the like. The natural language description of the input video, or embeddings derived therefrom, may then be used in generating 706 the customized video content. For example, in some embodiments, the natural language description of the input video may serve as additional contextual information for a machine learning model generating the customized video content so that the replacement content may be similar or contextually relevant to the original input video. As another example, the natural language description of the input video may provide a contextual understanding of the behavior or movements of the identified objects to ensure temporal and spatial consistency between the replacement video content and the objects from the input video.

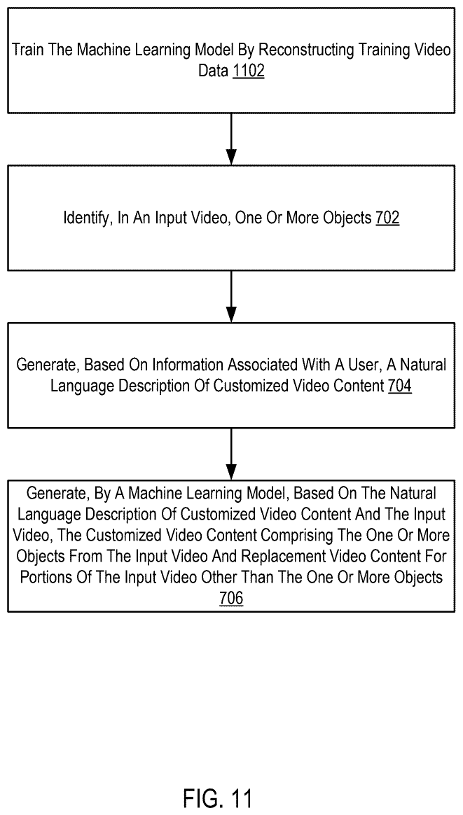

For further explanation, FIG. 11 sets forth a flowchart of another example method of customizing video content using machine learning models in accordance with some embodiments of the present disclosure. The method of FIG. 11 is similar to FIG. 7 in that the method of FIG. 11 also includes: identifying 702, in an input video, one or more objects; generating 704, based on information associated with a user, a natural language description of customized video content; and generating 706, by a machine learning model, based on the natural language description of customized video content and the input video, the customized video content comprising the one or more objects from the input video and replacement video content for portions of the input video other than the one or more objects.

The method of FIG. 11 differs from FIG. 7 in that the method of FIG. 11 also includes training 1102 the machine learning model by reconstructing training video data. Training 1102 the machine learning model may be performed using similar approaches as are set forth above. For example, training video data may be converted into latent representation. Noise may be introduced into the latent representations using a scheduler. A machine learning model, or combinations thereof, may adjust and condition these latent representations using control signals such as masks of identified objects, embeddings of descriptions of descriptions of the input video data, and the like. The output of the machine learning model may then be reencoded into a reconstructed version of the training video data. The machine learning model may be trained by modifying parameters so as to minimize differences between the input training video data and the reconstructed training video data.

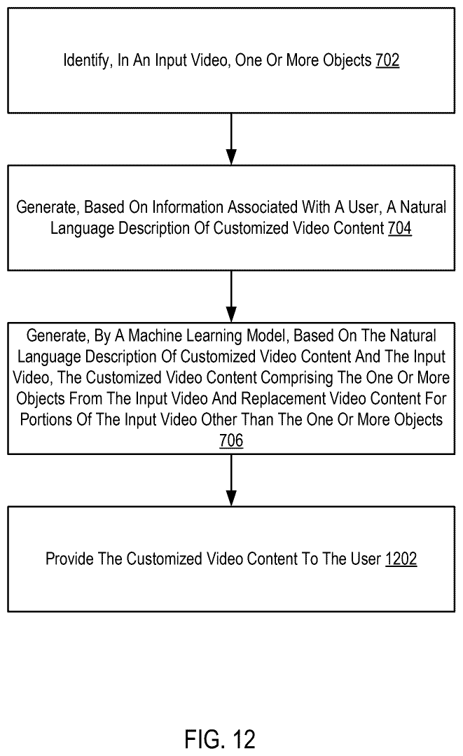

For further explanation, FIG. 12 sets forth a flowchart of another example method of customizing video content using machine learning models in accordance with some embodiments of the present disclosure. The method of FIG. 12 is similar to FIG. 7 in that the method of FIG. 12 also includes: identifying 702, in an input video, one or more objects; generating 704, based on information associated with a user, a natural language description of customized video content; and generating 706, by a machine learning model, based on the natural language description of customized video content and the input video, the customized video content comprising the one or more objects from the input video and replacement video content for portions of the input video other than the one or more objects.

The method of FIG. 12 differs from FIG. 7 in that the method of FIG. 12 also includes providing 1202 the customized video content to the user. Providing 1202 the customized video content may be performed using any content delivery system as can be appreciated. In some embodiments, the customized video content may be generated 706 and then stored until it is to be provided 1202 to the user or to another intermediary. For example, providing 1202 the customized video content to the user may include inserting the customized video content into an on-demand or linear stream or broadcast of video content accessed by the user (e.g., using a device or account associated with the user). As another example, providing 1202 the customized video content to the user may include making the customized video content accessible to a video delivery and/or video transmission service or other content delivery service that may then provide the customized video content to the user, e.g., by transmitting the customized video over the internet to a computer associated with the user. Other approaches may also be used in providing 1202 the customized video content to a user.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying, by a first machine learning model, one or more objects in an input video;
generating, based on information associated with a user and via a second machine learning model, a natural language description of customized video content; and
generating, by a third machine learning model, based on the natural language description of customized video content and the input video, the customized video content comprising the one or more objects from the input video and replacement video content for portions of the input video other than the one or more objects.

2. The computer-implemented method of claim 1, wherein generating the natural language description of the customized video content comprises:
generating, based on the information associated with a user, a user persona; and
generating, based on the user persona, the natural language description of the customized video content.

3. The computer-implemented method of claim 2, wherein the user persona and the natural language description of the customized video content are generated using the second machine learning model.

4. The computer-implemented method of claim 2, wherein the user persona is generated using a fourth machine learning model.

5. The computer-implemented method of claim 2, wherein generating the natural language description of the customized video content further comprises generating the natural language description of the customized video content based on context data.

6. The computer-implemented method of claim 1, further comprising generating a natural language description of the input video via a machine learning model, wherein the customized video content is generated based on the natural language description of the customized video content.

7. The computer-implemented method of claim 1, further comprising training the third machine learning model by reconstructing training video data, wherein the generating of the customized video content is performed via the trained third machine learning model.

8. The computer-implemented method of claim 7, wherein the training the third machine learning model by reconstructing training video comprises:
identifying one or more objects in a training video;
generating masks for the identified one or more objects; and
reconstructing the training video based on the generated masks.

9. The computer-implemented method of claim 8, wherein the training the third machine learning model by reconstructing training video further comprises inputting noise into latent representations that were generated from the training video, and wherein parameters of the third machine learning model are iteratively modified across training cycles to minimize differences between the training video and the reconstructed training video.

10. The computer-implemented method of claim 1, further comprising presenting the customized video content via a display screen.

11. The computer-implemented method of claim 1, wherein the customized video content is customized based on at least one member selected from a group consisting of: an interest of the user, a geographical region of the user, a season, an upcoming holiday for a community of the user, and an upcoming event for the user.

12. A computer system comprising:
a processor set;
one or more computer readable storage media; and
program instructions stored on the one or more storage media to cause the processor set to perform operations comprising:
identifying, in an input video, one or more objects;
generating, based on information associated with a user, a natural language description of customized video content; and
generating, by a machine learning model, based on the natural language description of customized video content and the input video, the customized video content comprising the one or more objects from the input video and replacement video content for portions of the input video other than the one or more objects.

13. The computer system of claim 12, wherein generating the natural language description of the customized video content comprises:
generating, based on the information associated with a user, a user persona; and
generating, based on the user persona, the natural language description of the customized video content.

14. The computer system of claim 13, wherein the user persona and the natural language description of the customized video content are generated using at least one other machine learning model.

15. The computer system of claim 13, wherein generating the natural language description of the customized video content further comprises generating the natural language description of the customized video content based on context data.

16. The computer system of claim 12, wherein the operations further comprise generating a natural language description of the input video, wherein the customized video content is generated based on the natural language description of the customized video content.

17. The computer system of claim 16, wherein the natural language description of the input video is generated using another machine learning model.

18. The computer system of claim 12, wherein the operations further comprise training the machine learning model by reconstructing training video data.

19. The computer system of claim 12, wherein the operations further comprise providing the customized video content to the user.

20. A computer program product comprising:
one or more computer readable storage media; and
program instructions stored on the one or more storage media to perform operations comprising:
identifying, in an input video, one or more objects;
generating, based on information associated with a user, a natural language description of customized video content;
generating, by a machine learning model, based on the natural language description of customized video content and the input video, the customized video content comprising the one or more objects from the input video and replacement video content for portions of the input video other than the one or more objects; and
providing the customized video content to the user.
